(19) United States
(12) Patent Application Publication
(10) Pub. No.: US 2010/0115904 A1
(43) Pub. Date: May 13, 2010

(54) SUGARCANE HARVESTER WITH A ROTATING MEMBER AND A COUNTER ROTATING BLADE MEMBER

(75) Inventor: Christopher Cannavan, Home Hill (AU)

Correspondence Address: Barnes & Thornburg LLP, Atlanta Financial Center, 3343 Peachtree Road N.E., Suite 1150, Atlanta, GA, 30326-1428, US

(73) Assignee: CANNAVAN CANE TECHNOLOGY PTY LTD, Home Hill (AU)

(21) Appl. No.: 12/518,435

(22) PCT Filed: Dec. 10, 2007
(86) PCT No.: PCT/AU07/01899

§ 371 Date: Jan. 4, 2010

(30) Foreign Application Priority Data
Dec. 11, 2006 (AU) 2006906908

(51) Int. Cl. A01D 34/00; A01D 61/00

(52) U.S. Cl. 56/13.9; 56/16.4 R

(57) ABSTRACT

A cutting assembly having a first member in the form of three paddles, each paddle comprising a planar main body portion and a pair of leg members attached to a first tubular rotating shaft. A blade member is provided which is substantially U-shaped and has a pair of leg portions and an interconnecting portion which comprises the cutting blade. The leg portions are attached to a second rotating shaft which sits within the first shaft and rotates in the opposite directon to the first shaft. When uncut sugarcane is pushed sufficiently into the cutting assembly, the cane will be pushed upwardly by being struck by a paddle and at the same time will be cut into billets by the counter rotating blade member. The billet will then be flung or thrown upwardly by the force of the rotating paddle.

### PRIORITY CLAIM OR CROSS REFERENCE TO RELATED APPLICATIONS

This patent application is a U.S. National Phase of International Patent Application No. PCT/AU2007/001899, filed Dec. 10, 2007, which claims priority to Australian Patent Application No. 2006906908, filed Dec. 11, 2006, the disclosures of which are incorporated herein by reference in their entirety.

### FIELD

This invention is directed to improvements to a sugarcane harvester and particularly improvements to the parts of the sugarcane harvester that cut the cane into billets and the part of the harvester that conveys the cut billets into a cane bin or something similar. For instance, one improvement can be directed to the elevating system.

### BACKGROUND

A sugarcane harvester is a self-propelled machine that travels along a sugarcane field to harvest the sugarcane. Many types of harvesters are known and FIG. 1 illustrates a particular conventional type of harvester. These harvesters typically have a forward topper that cuts the bushy top parts off the sugarcane plant. A pair of spiral crop dividers are positioned in front of the harvester to divide the crop and also to straighten the sugarcane stalks. A cutter cuts the base of the sugarcane plants. The plants are fed into the harvesting machine that cuts the plants into short lengths called billets. The billets are passed onto an elevator which passes the billets into an adjacent truck or trailer.

The elevator part of the harvester usually contains some form of conveyor chain or something similar, is expensive and adds a considerable amount of weight to the remainder of the harvester. Consequently, it is usually necessary for the harvester to be supported by tracks. Also, the weight of the harvester compacts and compresses the soil as the harvester moves along the field to harvest the sugarcane. The weight of the harvester also increases its power requirements, which also contributes to increased operating cost.

Therefore, there would be an advantage if it were possible to provide a harvester which did not have the conventional type of elevator.

Another part of the sugarcane harvester which is expensive and which requires regular maintenance is the chopper assembly. The chopper assembly typically comprises a pair of counter rotating chopper drums containing long blades extending along each drum. The sugarcane passes between the counter rotating chopper drums and is cut into lengths (often called billets). It is found that the chopper drums require expensive maintenance, usually each season. During operation of the chopper assembly, occasionally, a stone will be inadvertently collected and will pass into the chopper assembly and will damage the blades of the chopper drums. Removal and replacement of the blade is time-consuming and expensive.

Therefore, there would be an advantage if it were possible to provide a different type of chopper assembly which does not require counter rotating chopper drums and expensive blades which are difficult to replace if damaged.

In the conventional chopper assembly, once the cane is cut into billets, it falls onto the base of the elevator (see FIG. 1) and is then elevated up to the secondary extractor. The elevator is necessary because the cut billets need to pass into the top of a cane bin or something similar which is usually towed by a tractor next to the harvester.

There would be an advantage if it were possible to provide a different type of chopper assembly where the chopper assembly can also function to facilitate elevation of the cut billets such that the billets can drop into a cane bin or something similar.

It will be clearly understood that, if a prior art publication is referred to herein, this reference does not constitute an admission that the publication forms part of the common general knowledge in the art in Australia or in any other country.

### SUMMARY

The present disclosure describes several exemplary embodiments of the present invention.

One aspect of the present disclosure provides a chopper assembly for a sugarcane harvester, the chopper assembly comprising a) a first rotating member along which the sugarcane can pass; and b) a counter rotating blade member which cuts the sugarcane into billets.

Another aspect of the present disclosure provides an elevating assembly for elevating sugarcane billets, the elevating assembly comprising a) a throwing assembly for throwing the billets; b) a passageway to guide the thrown billets, the passageway being generally upright such that as the billets are thrown along the passageway the billets will be elevated; c) a partition in an upper portion of the passageway, the partition partially blocking the passageway but not fully blocking the passageway, the partition leaving a space through which the billets can pass; d) an outlet in the passageway on the other side of the partition from the throwing assembly and through which the billets can pass to be collected; and e) a blower on the other side of the partition which blows air into the passageway and which facilitates passage of the billets through the outlet.

A further aspect of the present disclosure provides a chopper assembly substantially as hereinbefore described with reference to the accompanying drawings.

An additional aspect of the present disclosure provides an elevating assembly substantially as hereinbefore described with reference to the accompanying drawings.

It is a feature of the invention to provide improvements to a harvester and particularly to a sugarcane harvester and especially improvements to the cutting assembly that cuts the cane into billets and the elevating means that elevate the cut billets. It is a further feature to provide improvements to a harvester and particularly to a sugarcane harvester that may overcome at least some of the above-mentioned disadvantages or provide a useful or commercial choice.

In one form, the invention comprises a chopper assembly for a harvester and particularly for a sugarcane harvester, the chopper assembly comprising a first rotating member along which the sugarcane can pass, and a counter rotating blade member which cuts the sugarcane into billets.

The chopper assembly can also be called the cutter assembly.

In this manner, elongate counter rotating rollers are not required and there is no need to have expensive elongate knives or blade members which extend longitudinally along each roller and which are difficult to remove and repair.

Instead, a relatively inexpensive rotating blade member is provided to cut the sugarcane into billets and, should the blade member be damaged, it is relatively easy and relatively inexpensive to change the rotating blade member.

The first rotating member may rotate at a rotational speed of between 20-100 km per hour and preferably around 60 km per hour.

The counter rotating blade member may rotate at a rotational speed of between 100-250 km per hour and preferably at approximately 180 km per hour.

Thus, the cane can come into contact with the blade member typically at a passing speed of about 240 km per hour.

The first rotating member may comprise a somewhat flat or planar area or may comprise a platform or paddle type arrangement to support part of the sugarcane after the sugarcane has been cut by the counter rotating blade member.

It is preferred that the first member comprises a paddle. The paddle may have a substantially flat main body portion and a pair of leg members. The leg members may be attached to a shaft or something similar that can be rotated thereby rotating the paddle.

Any type of suitable drive means may be used to rotate the shaft. The drive means may be powered by the sugarcane harvester and may comprise a hydraulic motor, an electric motor, a pneumatic motor or an internal combustion motor and the drive means may be directly connected to the shaft or connected to the shaft via some form of pulley, belts, chain, cogs, and the like.

It is preferred that a plurality of paddles are provided and it is envisaged that these paddles will be spaced substantially equidistance apart about the shaft. It is envisaged that the number of paddles will be between 2-10.

The blade member may comprise a somewhat U-shaped member comprising a pair of leg portions and an interconnecting portion. The interconnecting portion may contain the cutting edge. The leg portions may be connected to a rotating shaft such that rotation of the shaft causes rotation of the blade member. It is envisaged that the blade member may have other configurations and not necessarily a U-shaped configuration providing that a cutting edge is still provided and that the blade member can rotate. For instance, the blade member may be L-shaped, or T shaped.

To provide a good cutting action, the paddle and the blade member may be designed and configured such that the paddle rotates within the confines of the blade member. For instance, if the blade member is substantially U-shaped, the paddle may be made smaller such that it can rotate within the confines of the blade member but without striking the blade member. In other words, the paddle may rotate concentrically, but in the opposite direction to the blade member.

It is preferred that a single blade member is provided which counter rotates relative to the first rotating member, however there may be circumstances where a pair of blade members, or a plurality of blade members is provided.

It is preferred that the blade member counter rotates relative to the first rotating member (for instance the paddle) as this can provide a good cutting action. However, there may be circumstances where the blade member can rotate in the same direction as the paddle but at a different speed such that a cutting action still occurs.

The blade member may be driven by any suitable drive means and this may be the same, similar or different to the drive means of the paddle and as described above.

The first rotating member (e.g. paddle) and the blade member are typically arranged such that the paddle provides an upward thrust to the sugarcane while the blade member provides a downward cutting action.

An advantage of this arrangement is that when the sugarcane is cut into billets, the paddle will act as a “thrower” to fling the sugarcane billets away from the cutting assembly.

Another advantage with this arrangement is that the force or thrust on the sugarcane billets may be sufficient to throw the billets a substantial distance and thus it may be possible to “elevate” the billets by a throwing action thereby doing away with the need for an expensive and heavy conventional conveyor type elevator as illustrated in FIG. 1.

In another form, the invention resides in an elevating assembly to elevate sugarcane billets (or other cut material), the elevating assembly comprising a throwing assembly, a passageway (for instance a chute) to guide the thrown billets, the passageway being generally upright such that as the billets are thrown along the passageway, the billets will be elevated, a partition in the passageway, the partition partially blocking the passageway but not fully blocking the passageway, the partition leaving a space through which the billets can pass, an outlet in the passageway on the other side of the partition and through which the billets can pass to be collected, and a blower which blows air into the passageway which is on the other side of the partition and which facilitates passage of the billets through the outlet.

An embodiment of this form of the invention is illustrated in FIG. 2. In this particular embodiment, a throwing assembly is provided in a lower part of the passageway and the billets that come into contact with a throwing assembly are thrown along the passageway and towards the partition. The partition may be somewhat inclined such that the billets that strike the partition are pushed along the partition and ultimately through the space between the partition and the wall of the passageway and into the passageway on the other side of the partition.

A blower can direct a strong flow of air against the billets on the other side of the partition to reduce the velocity of the billets and to cause the billets to fall down under the influence of gravity through a lower opening.

Another advantage of the blower is that it can also function to remove trash by blowing the trash through the opening but away from the billets.

The elevating assembly can replace the conventional conveyor type elevator which is found on conventional sugarcane harvesters and can reduce the weight and cost of the harvester.

The throwing assembly will typically comprise any device or apparatus or means or mechanism that can throw the billets along the passageway. This may comprise a high-speed rotating paddle type apparatus. This may also comprise a blowing device or something similar.

It is particularly preferred that the throwing assembly comprises the cutting assembly described previously which means that the sugarcane can be cut by the cutting assembly and thrown along the passageway.

However, it is also envisaged that the throwing assembly may be separate from the cutting assembly.

The passageway will typically comprise an elongate chute or something similar which may be made of any suitable material but will typically be made of thin wall metal. It is envisaged that the passageway will typically be somewhat tapered from a larger lower portion to a narrower upper portion. The passageway will typically have an inlet which may be positioned in the larger lower portion and an outlet which may be positioned in the narrower upper portion. The length of the passageway may vary but it is envisaged that the passageway will have a length of between 1-5 m. often it will be around 4 m long.

The passageway may be curved from a lower substantially vertical portion to an upper substantially horizontal portion. FIG. 2 illustrates a preferred shape of the passageway but it is not considered that the invention should be limited only to the shape illustrated in FIG. 2.

The cross-section size of the passageway may vary but it is envisaged that the cross-section at the lower end will be between 0.4-2 m and the cross-section at the upper end will be between 0.4-1 m. This can of course vary to suit. The cross-section shape of the passageway can vary but it is envisaged that the passageway will be substantially rectangular although the passageway may also be circular or oval and the like.

The passageway will typically be substantially enclosed and the wall of the passageway will typically be substantially continuous although there may be circumstances where the wall of the passageway may comprise a mesh or something else providing that this does not unduly interfere with the passage of the billets along the passageway.

Some form of guide means may be provided in the passageway to assist in the passage of the billets towards the outlet. The guide means may comprise internal projections, flaps and the like.

It may also be necessary to provide some further assistance in the passage of the billets along the passageway. Therefore, it may be necessary to provide air jets or something similar to assist in blowing or otherwise conveying the billets along the passageway.

The passageway contains a partition. One function of the partition is to prevent the blower from blowing air down the passageway in the reverse direction thereby impeding the movement of billets up the passageway. The partition may be made of any suitable material and one suitable material may comprise rubber. The partition will typically be substantially rigid. The partition may extend across the passageway at any suitable angle and it is considered preferable for the partition to be slightly angled towards the blower to provide a somewhat inclined surface to assist billets that may strike the wall of the partition to move along the wall and to the other side of the partition.

The partition does not entirely block the passageway but should provide some form of barrier against air from the blower blowing down the passageway. Typically, the partition extends from a lower or bottom wall of the passageway and towards an upper or top wall of the passageway and leaves the spacing sufficient to allow the billets to pass through the spacing and to the other side of the passageway. FIG. 2 illustrates a partition according to an embodiment of the invention but it is not considered that the invention should be limited only to the partition illustrated in FIG. 2.

The spacing may be between 20-100 cm.

The billets and the trash that pass along the passageway can pass through the spacing between the partition and the passageway and to the other side.

The upper end of the passageway will typically be provided with an outlet and it is preferred that the outlet is in a bottom wall of the passageway such that the billets/trash can fall under the influence of gravity through the outlet. The outlet may comprise a rectangular opening or an opening of other configurations.

A blower is typically provided to blow air against the billets/trash that pass over the partition such that the velocity of the billets/trash is slowed to the point that the billets/trash drop-down through the opening.

It is envisaged that the blower will be attached to the upper end of the passageway as illustrated in FIG. 2 although the blower may be positioned somewhere else and some form of conduit may be provided to pass the air against the billets/trash.

The blower may comprise a conventional type blower.

### BRIEF DESCRIPTION OF THE DRAWINGS

Various aspects of the present disclosure are described hereinbelow with reference to the accompanying figures.

An embodiment of the invention will be described with reference to the following drawings in which:

FIG. 1 illustrates a conventional sugarcane harvester having a conventional chopping assembly and a conventional elevating assembly.

FIG. 2 illustrates a device that can replace the elevator and which comprises a passageway (chute) having a throwing device in the lower end of the passageway, a partition, and outlet on the other side of the partition, and a blower on the other end of the passageway.

FIG. 3 illustrates a cutting assembly that can replace the chopper drums in a conventional sugarcane harvester.

FIG. 4 illustrates a side view of the cutting assembly.

FIG. 5 illustrates a line drawing of the device of FIG. 2.

FIG. 6 illustrates schematically attachment of the chute to the rear of a sugarcane harvester.

### DETAILED DESCRIPTION

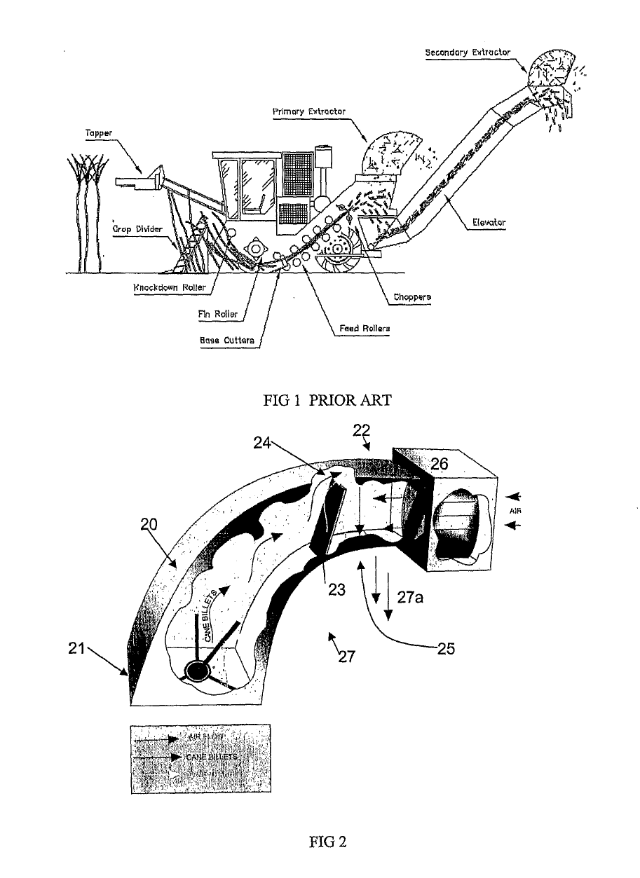

FIG. 1 illustrates a particular conventional type of harvester. These harvesters typically have a forward topper that cuts the bushy top parts off the sugarcane plant. A pair of spiral crop dividers are positioned in front of the harvester to divide the crop and also to straighten the sugarcane stalks. A cutter cuts the base of the sugarcane plants. The plants are fed into the harvesting machine that cuts the plants into short lengths called billets. The billets are passed onto an elevator which passes the billets into an adjacent truck or trailer.

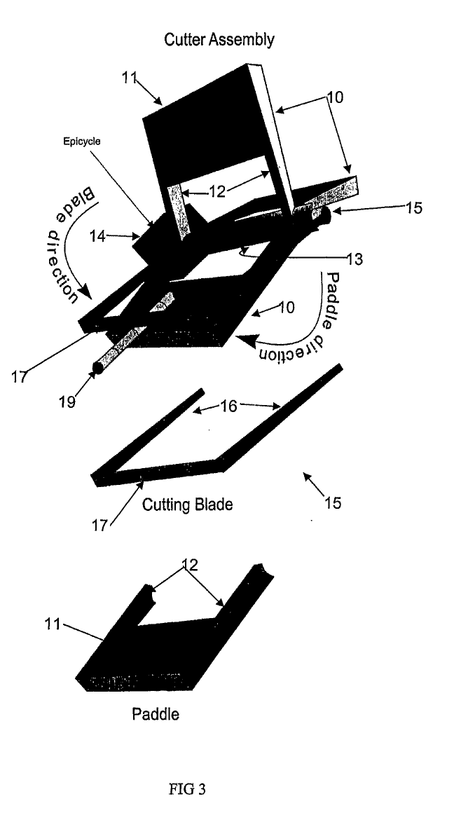

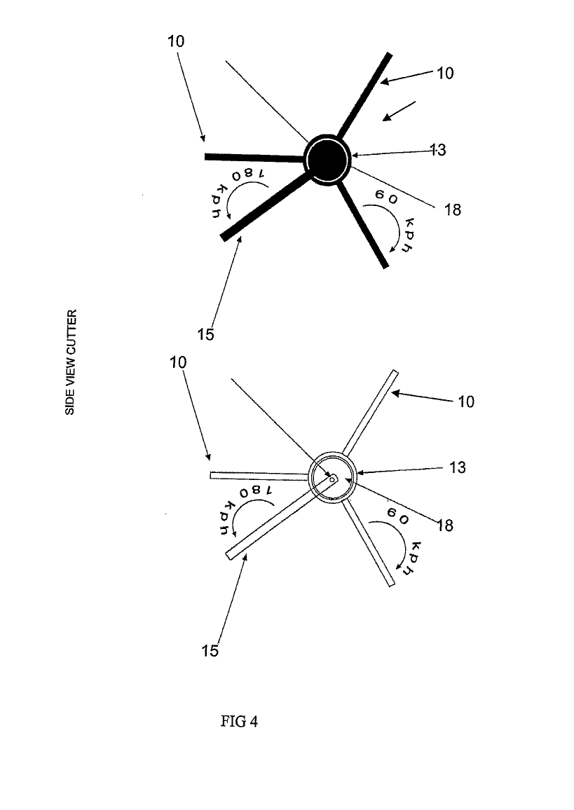

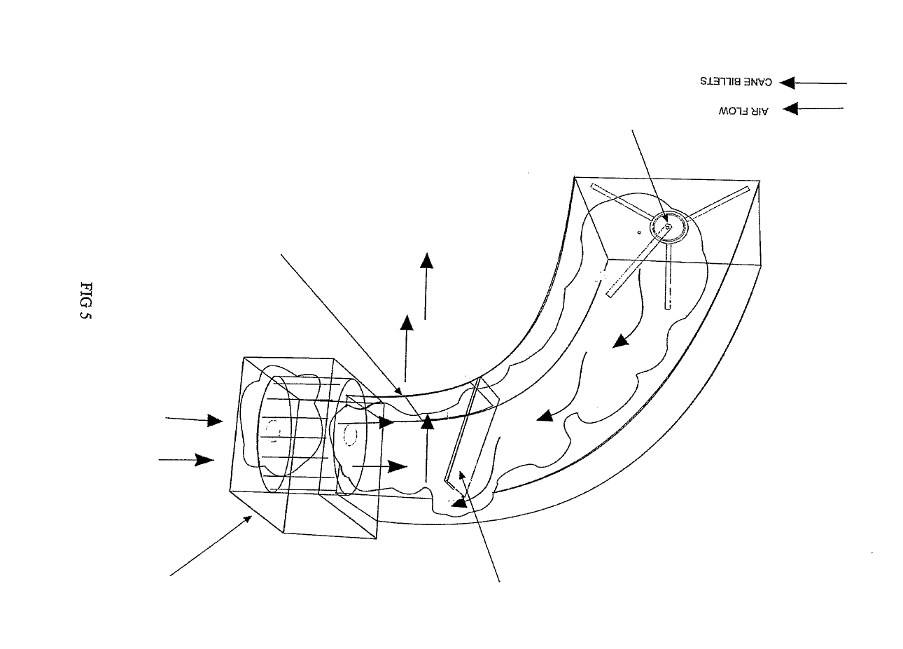

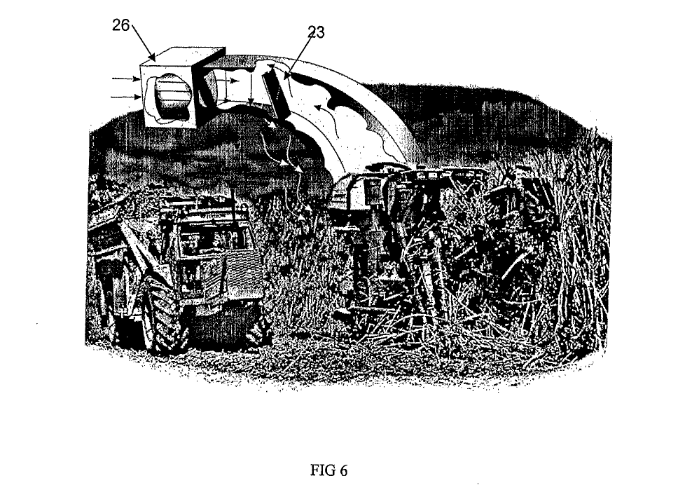

FIGS. 3-4 illustrate a cutting assembly that can be used to replace the chopper drums in a sugarcane harvester. The cutting assembly comprises a first member in the form of a number of paddles 10, and in the particular embodiment, three paddles 10 are illustrated. Each paddle comprises a planar main body portion 11 and a pair of leg members 12. The leg members 12 attached to a tubular rotating shaft 13 which is better illustrated in FIG. 4. Some form of drive means 14 rotates the shaft. In the particular embodiment, the paddles are rotated in a clockwise direction at approximately 60 km per hour.

A blade member 15 is provided which is substantially U-shaped and which comprises a pair of leg portions 16 and an interconnecting portion 17 which comprises the cutting blade. The leg portions 16 are attached to a rotating shaft 18 which is better illustrated in FIG. 4. Shaft 18 sits within shaft 13. Shaft 18 rotates in the opposite direction to shaft 13 and in the particular embodiment, the blade member 15 rotates in an anticlockwise direction at about 180 km per hour. Some form of epicycle gearing system can be provided.

The size and configuration of paddles 10 is such that each paddle can rotate within the confines of blade member 15 this being particularly illustrated in FIG. 3.

Feedstock (for instance uncut cane 19), is harvested by the sugarcane harvester and passes along feed rollers (see for instance the feed rollers in FIG. 1) towards the cutting assembly of FIG. 3. When the cane 19 is pushed sufficiently into the cutting assembly, the cane will be pushed upwardly by being struck by a paddle 10 and at the same time will be cut into billets by the counter rotating blade member 15.

The billet will then be flung or thrown upwardly by the force of the rotating paddle 10.

Referring now to FIG. 2, there is illustrated an apparatus that can replace the conventional elevator on the rear of a sugarcane harvester (see FIG. 1). The device comprises a passageway in the form of a chute 20 which is generally curved from a substantially vertical lower end 21 to a substantially horizontal upper end 22. The lower end 21 is open and contains a throwing device and, in the particular embodiment, the throwing device is the cutting assembly illustrated in FIG. 3. Thus, as cane/trash 19 passes into the cutting assembly, the cane is cut and the billets (cut cane) and trash is flung along chute 20 by the rotational action of the paddles 10.

A partition 23 in the form of a rigid rubber flap is positioned in an upper part of chute 20. Partition 23 extends from a lower wall of the chute and towards the upper wall of the chute but importantly does not entirely block the passageway. Instead, an opening 24 is provided in the upper part of the passageway.

As the billets/trash are flung along the passageway by the fast rotating paddles 10, some of the material will travel straight through opening 24 and to the other side of the partition 23. It will be appreciated that the billets/trash are flung with sufficient force/velocity that they mostly travel along the curved upper wall of the chute and straight through the opening 24. However, some material will strike partition 23, but the velocity of the material will cause the material to be pushed along the partition and through the opening 24. The partition may be slightly inclined to assist in this action.

The partition may also be hinged if desired.

On the other side of the partition is a lower outlet 25.

At the end of the chute 20 is a blower 26 which directs a blast of air along the chute and the air is prevented from passing entirely down the chute by the partition 23.

Blower 26 will reduce the forward velocity of the billets/trash as this material passes through opening 24, and once the material has been slowed down by the blast of air from blower 26, the material will fall under gravity through outlet 25 and into a cane bin, or an elevator or some other collection or transfer device. The blower air may also assist in blowing the billets/trash through the outlet.

As the billets/trash passes through outlet 25, blower 26 will blow the light trash to one side (see arrows 27) while the heavier billets will drop straight down into a collection bin etc (see arrows 27a).

The blade in the cutting assembly is made of a flexible and brittle material and this provides excellent cutting ability. If the blade encompasses solid foreign material (rocks, metal etc) it shatters reducing the chance of damage to the rest of the unit. The blade can be replaced very cheaply and relatively quickly. The blade may be similar in material to a hacksaw blade.

The improvements allow the weight of the harvester to be reduced thereby allowing development of the harvester as a two row machine as opposed to a single row harvester. Pervious attempts to modify a single row harvester into a two row harvester, or development of a two row harvester has resulted in a machine of excessive weight in the paddock which has required a machine with tracks instead of wheels, which has resulted in problems with soil compaction and turning circle difficulties.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

1. A chopper assembly for a sugarcane harvester, the chopper assembly comprising:
a) a first rotating member along which the sugarcane can pass and
b) a counter rotating blade member which cuts the sugarcane into billets.

2. The chopper assembly of claim 1, wherein the first rotating member rotates at a rotational speed of between 20-100 km per hour.

3. The chopper assembly of claim 1, wherein the first rotating member rotates at a rotational speed of between 100-250 km per hour.

4. The chopper assembly of claim 1, wherein the first rotating member comprises a paddle for supporting part of the sugarcane after the sugarcane has been cut by the counter rotating blade member.

5. The chopper assembly of claim 4, wherein the paddle has a substantially flat main body portion and a pair of leg members.

6. The chopper assembly of claim 5, wherein the leg members are attached to a shaft that can be rotated to thereby rotate the paddle.

7. The chopper assembly of claim 6, further comprising drive means to rotate the shaft.

8. The chopper assembly of claim 6, further comprising a plurality of paddles wherein the paddles are spaced substantially equidistantly about the shaft.

9. The chopper assembly of claim 1, wherein the blade member comprises a U-shaped member having a pair of leg portions and an interconnecting portion, the cutting edge being on the interconnecting portion.

10. The chopper assembly of claim 9, wherein the leg portions of the blade member are connected to a shaft such that rotation of the shaft causes rotation of the blade member.

11. The chopper assembly of claim 1, wherein the first rotating member rotates within the confines of the blade member.

12. The chopper assembly of claim 1, further comprising drive means for driving the blade member.

13. The chopper assembly of claim 1, wherein the first rotating member and the blade member are arranged such that the first rotating member provides an upward thrust to the sugarcane while the blade member provides a downward cutting action.

14. The chopper assembly of claim 13, wherein the upward thrust flings the sugarcane billets up away from the chopper assembly, thus elevating the billets as required to deliver the billets into an adjacent trailer or other receptacle.

15. An elevating assembly for elevating sugarcane billets, the elevating assembly comprising:
a) a throwing assembly for throwing the billets;
b) a passageway to guide the thrown billets, the passageway being generally upright such that as the billets are thrown along the passageway the billets will be elevated;
c) a partition in an upper portion of the passageway, the partition partially blocking the passageway but not fully blocking the passageway, the partition leaving a space through which the billets can pass;
d) an outlet in the passageway on the other side of the partition from the throwing assembly and through which the billets can pass to be collected; and
e) a blower on the other side of the partition which blows air into the passageway and which facilitates passage of the billets through the outlet.

16. The elevating assembly of claim 15, wherein the throwing assembly comprises a chopper assembly wherein the first rotating member and the blade member of the chopper assembly are arranged such that the first rotating member provides an upward thrust to the sugarcane while the blade member provides a downward cutting action, and wherein the upward thrust flings the sugarcane billets up away from the chopper assembly, thus elevating the billets as required to deliver the billets into an adjacent trailer or other receptacle.

17. The elevating assembly of claim 15, wherein the partition is inclined such that the billets that strike the partition are pushed along the partition and ultimately through the space.

18. The elevating assembly of claim 15, wherein the blower reduces the velocity of the billets and causes the billets to fall down under the influence of gravity through the outlet.

19. The elevating assembly of claim 18, wherein the blower functions to remove trash associated with the sugarcane billets by blowing the trash through the outlet but away from the billets.

20. The elevating assembly of claim 15, wherein the passageway comprises an elongate chute which is tapered from a larger lower portion to a narrower upper portion, the passageway having an inlet in the lower larger portion and the outlet in the narrower upper portion.

21. The elevating assembly of claim 20, wherein the passageway is curved from a substantially vertical lower portion to a substantially horizontal upper portion.

22. The elevating assembly of claim 18, wherein the partition extends across the passageway and is angled towards the blower to provide an inclined surface to assist the billets that strike the partition to move along the passageway to the other side of the partition, and the partition prevents the blower from impeding movement of the billets up the passageway by blowing air down the passageway.

23. The elevating assembly of claim 22, wherein the partition extends from a lower or bottom wall of the passageway towards an upper or top wall of the passageway but leaves a space between the partition and the top wall sufficient to allow the billets to pass through to the other side of the passageway from the throwing assembly.

24. The elevating assembly of claim 23, wherein the outlet is in the bottom wall of the passageway, but near the top of the passageway, such that billets and trash can fall through the outlet under the influence of gravity.

25. A chopper assembly substantially as hereinbefore described with reference to the accompanying drawings.

26. An elevating assembly substantially as hereinbefore described with reference to the accompanying drawings.
